(19) United States
(12) Patent Application Publication
(10) Pub. No.: US 2011/0230287 A1
(43) Pub. Date: Sep. 22, 2011

(54) CHAIN LATERAL TRAVEL LIMITER

(76) Inventors: Joseph Savola, Boise, ID (US); Eric L. Jensen, Boise, ID (US); Albert Savola, Boise, ID (US); Lawrence A. Rupe, Boise, ID (US)

(21) Appl. No.: 12/729,007

(22) Filed: Mar. 22, 2010

(51) Int. Cl. B62M 9/136; F16H 7/18; F16H 59/04; B62M 9/12

(52) U.S. Cl. 474/80; 474/140

(57) ABSTRACT

A lateral travel limiter for the chain of a chain drive assembly as commonly seen on multi-speed bicycles. The chain lateral travel limiter attached to a bicycle frame proximate to a front derailleur and the front chain rings, and is positioned with respect to the front derailleur and the front chain rings so that during a shifting event, and in the event that the front derailleur shifts the chain laterally from a first plane defined by an outer chain ring to second plane defined by an inner chain ring and the chain travels laterally beyond the second plane defined by the inner chain ring, the chain is caught against the chain lateral travel limiter and guided in a manner that redirects the chain to the plane of rotation defined by the chain when engaged and rotating on the inner chain ring.

### BACKGROUND OF THE INVENTION

1. Technical Field

The present invention relates generally to bicycles and more particularly to a cycle chain lateral travel limiter.

2. Background

It is common for bicycles and other pedaled vehicles to include a speed changing device. Often the speed changing device includes one or more chain derailleurs, a rear derailleur adapted to shift the chain up and down a range of sprockets that are attached to a drive wheel and a front derailleur adapted to shift the chain up and down at least a pair of front chain rings that are connected to a pair of crank arms.

When shifting the front derailleur, the chain, and a plane defined by the chain when engaged and rotating on a first chain ring, may be shifted laterally to a second ring and a therefore to a second plane defined by the chain when engaged and rotating on the second chain ring. When shifting the front derailleur from an outer chain ring having a larger diameter, to an inner chain ring having a smaller diameter, particularly under certain pedaling conditions, may result in the chain “jumping” beyond the inner chain ring, the bicycle chain drive becoming de-chained, often resulting in the chain becoming jammed between the crank arm and a frame bottom bracket housing. Adding further to the inconvenience of a “jumped” chain is the fact that a bicycle chain is most likely to jump the inner chain ring while the bicyclist is pedaling on or approaching an uphill grade so the ability to regain momentum following replacement of the chain on the sprocket is impaired.

One object of the present invention therefore is to provide a device that will substantially reduce the probability of a chain of a cycle chain drive “jumping” beyond the inner chain ring on operation of the front derailleur to shift the chain from an outer chain ring having to an inner chain ring.

Another object of the present invention therefore is to provide a device that will substantially reduce the probability of a chain of a cycle chain drive “jumping” beyond the inner chain ring on operation of the front derailleur to shift the chain from an outer chain ring to an inner chain ring having a diameter smaller than a diameter of the outer chain ring.

Yet another object of the present invention therefore is to provide a device that catches a chain that has jumped or traveled laterally beyond a plane of an inner chain ring on operation of the front derailleur to shift the chain from an outer chain ring having to an inner chain ring and return the chain the plane defined by the inner chain ring.

### SUMMARY OF THE INVENTION

In a broad sense, the present invention is directed to a chain lateral travel limiter adapted for attachment to a bicycle frame proximate to a front derailleur and the front chain rings, positioned with respect to the front derailleur and the front chain rings so that in the event that during a shifting operation wherein the front derailleur shifts the chain laterally from a first plane defined by an outer chain ring to second plane defined by an inner chain ring and the chain travels laterally beyond the second plane defined by the inner chain ring, the chain is caught against the chain lateral travel limiter and guided in a manner that redirects the chain to the plane of rotation defined by the chain when engaged and rotating on the inner chain ring.

In a preferred embodiment, the present invention is directed to a chain lateral travel limiter including a body having a head, the head adapted for attachment to a bicycle frame proximate to a front derailleur and the front chain rings. The chain lateral travel limiter also includes a chain return finger attached to and extending from the head. The chain return finger extends from the head out and away from the frame extending from a point vertically above the top of the inner chain ring and extending to a point vertically below the top of the inner chain ring. In one embodiment, the chain lateral travel limiter includes a neck interposed between the head and chain return finger.

In other embodiments chain lateral travel limiter may include a tube clamp for mounting the device to a bicycle frame proximate to a front derailleur and the front chain rings. Alternately the device may be mounted to the bottom bracket housing with a chain return finger extending upward from the bottom bracket housing to above the top of the inner chain ring.

### BRIEF DESCRIPTION OF THE FIGURES

FIG. 1 is a representative side view of a bicycle chain drive assembly including a lateral chain travel limiter according to the present invention.

FIG. 2 is a representative isometric detail view of a bicycle chain drive assembly including a lateral chain travel limiter according to the present invention.

FIG. 3 is a representative front detail view of a bicycle chain drive assembly including a lateral chain travel limiter according to the present invention.

FIG. 4 is a representative front detail view of a bicycle chain drive assembly including a lateral chain travel limiter according to the present invention.

FIG. 5 is a representative isometric view of a lateral chain travel limiter according to the present invention.

FIG. 6 is a representative front view of a lateral chain travel limiter according to the present invention.

### DETAILED DESCRIPTION

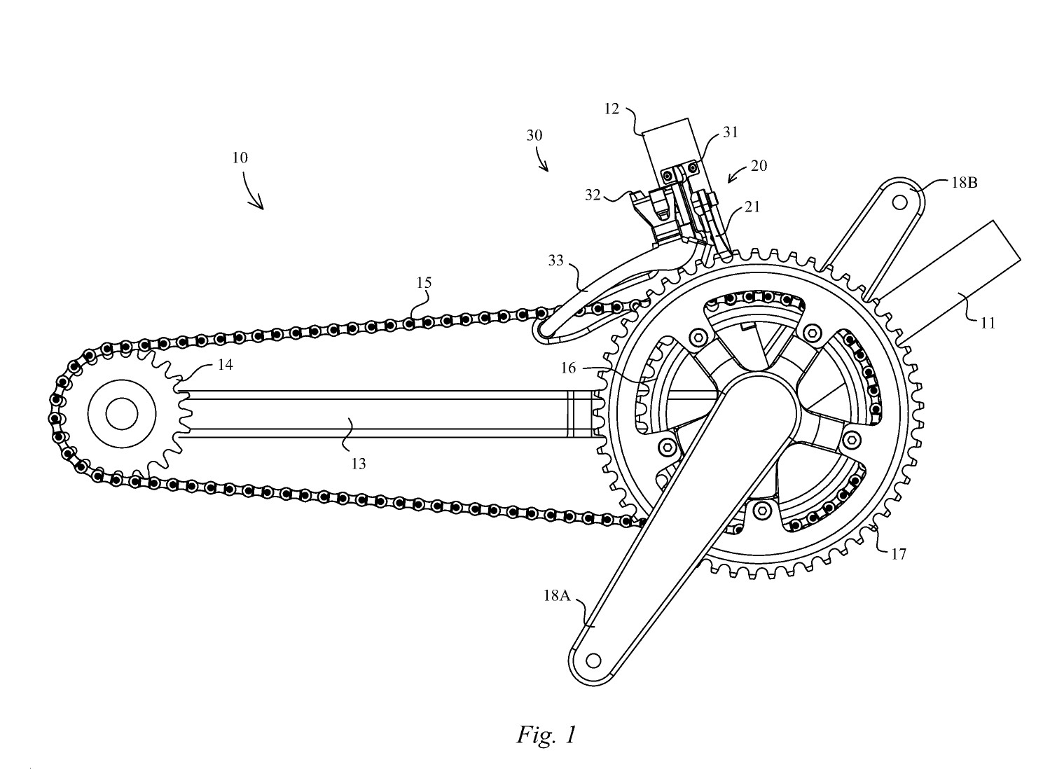

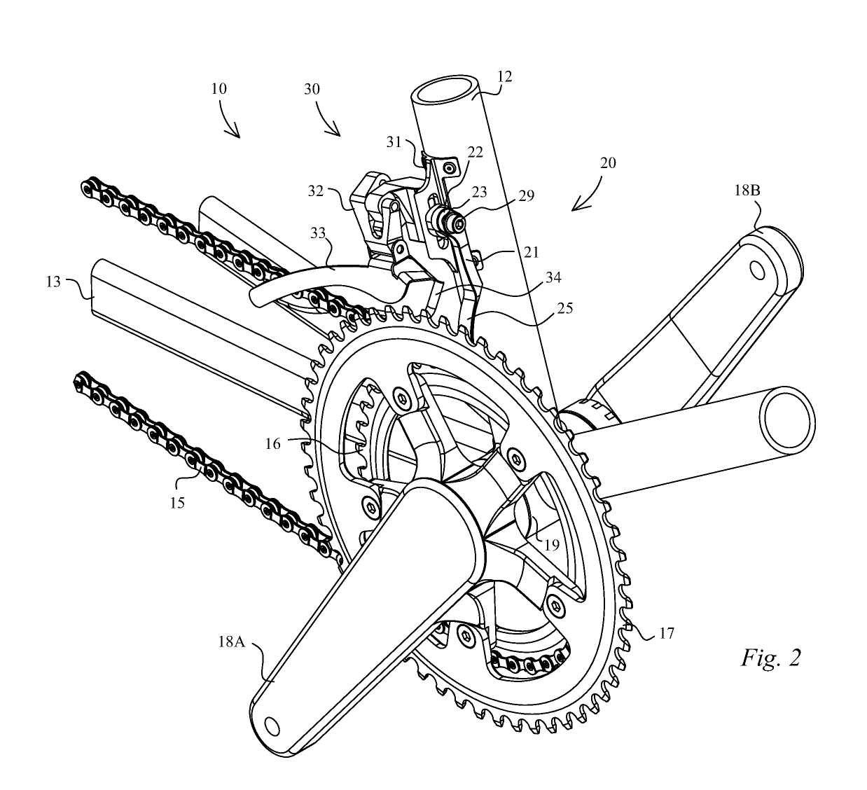

Referring to FIGS. 1 through 4 bicycle chain drive assembly 10 is shown including front dérailleur assembly 30 mounted to seat tube 12 of a bicycle frame in a manner well known in the prior art. Lateral chain travel limiter 20 is shown including body 21 mounted to seat tube 12. As shown in FIG. 1, bicycle chain drive assembly 10 includes chain 15 which is positioned about rear sprocket 14, located at a distal end of chain stay 13. As shown in FIGS. 1 and 2, inner chain ring 16 is mounted for rotational movement at an intersection of down tube 11 and seat tube 12. First crank arm 18A and second crank arm 18B are connected to one another and inner chain ring 16 and outer chain ring 17 on a bottom bracket, (not shown), housed in bottom bracket housing 19 seen in FIGS. 2 through 4.

Referring to FIGS. 1, 2 and 4 front dérailleur assembly 30 includes dérailleur mounting bracket 31 mounted to seat tube 12. Movable arm 32 is pivotably connected between dérailleur mounting bracket 31 and cage 33. Chain 15 is shiftable from inner chain ring 16 to outer chain ring 17, and vice versa, by front dérailleur assembly 30. More particularly movable arm 32 is operated by means well known in the prior art including cable and electrically controlled shift mechanisms, (not shown), to move cage 33 between an outer position wherein cage 31 is positioned over outer chain ring 17 to an inner position wherein cage 31 is positioned over inner chain ring 16.

As shown in FIGS. 1 through 4 and according to the preferred embodiment, lateral chain travel limiter 20 is shown mounted to front dérailleur mounting bracket 31. In other embodiments, lateral chain travel limiter 20 may be mounted by means of its own separate tube clamp so long as positioning of lateral chain travel limiter 20 with respect to front dérailleur assembly 30 and inner chain ring 16 may be effected in a manner that achieves the object of the invention, substantially reducing the probability that chain 15 of bicycle chain drive assembly 10 jumps beyond inner chain ring 16 on operation of front dérailleur assembly 30 to shift chain 15 from outer chain ring 17 to inner chain ring 16.

FIGS. 2 and 4, lateral chain travel limiter 20 is positioned forward of leading edge 34 of cage 33 of front dérailleur assembly 30. In operation, as chain 15 rotates with rear sprocket 14, (shown in FIG. 1), and inner and outer chain rings 16 and 17 respectively, and front dérailleur assembly 30 is operated in such a manner as to shift chain 15 from outer chain ring 17 to inner chain ring 16, that the segment of chain 15 located at or near a point just forward of leading edge 34 of cage 33, near elevation E1 or top dead center TDC, (shown in FIG. 4), that chain 15 has the greatest probability of jumping or traveling laterally beyond inner chain ring 16 during the shifting operation.

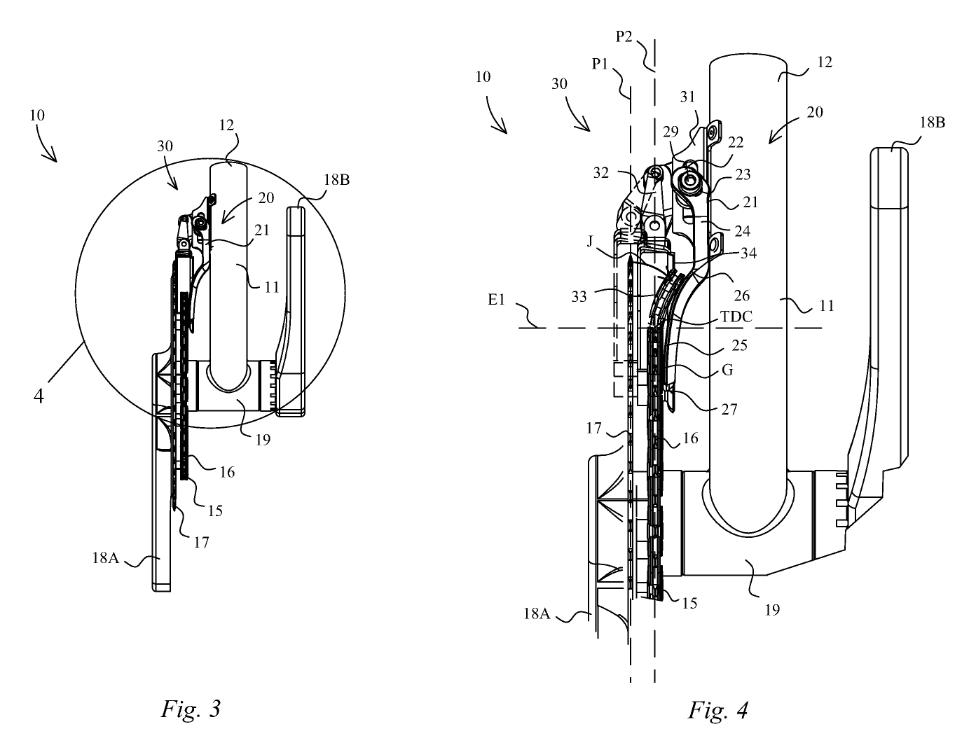

FIGS. 2 and 4 also show lateral chain travel limiter 20 including body 21 having head 22 through which mounting aperture 23 is formed. Screw 29 passes through mounting aperture 23 formed in head 22 of lateral chain travel limiter 20. Neck 24 is interposed between and connected at either end to head 22 and chain return finger 25. Referring to FIGS. 3 and 4, a portion of bicycle chain drive assembly 10 is shown in a representative front view. During a shifting event wherein front derailleur shift assembly 30 operates to shift chain 15 laterally from first plane P1 defined by outer chain ring 17 to second plane P2 defined by inner chain ring 16, and chain 15 travels laterally beyond second plane P2, jumping beyond inner chain ring 16 as indicated by the reference arrow “J” as chain 15 passes leading edge 34 of cage 33 of front dérailleur assembly 30. In such an event chain 15 is caught against chain return finger 25 of lateral chain travel limiter 20 and guided in a manner that redirects chain 15 to second plane P2 thus engaging with inner chain ring 16.

As seen in FIG. 4, when lateral chain travel limiter 20 is properly configured and mounted, chain return finger 25 extends out and away from neck 24 from neck/return transition 26 located vertically above elevation E1 of inner chain ring 16 and depending to tip 27 vertically below above elevation E1. In a preferred embodiment chain return finger 25 of lateral chain travel limiter 20 has a gently curved arcuate face 25.

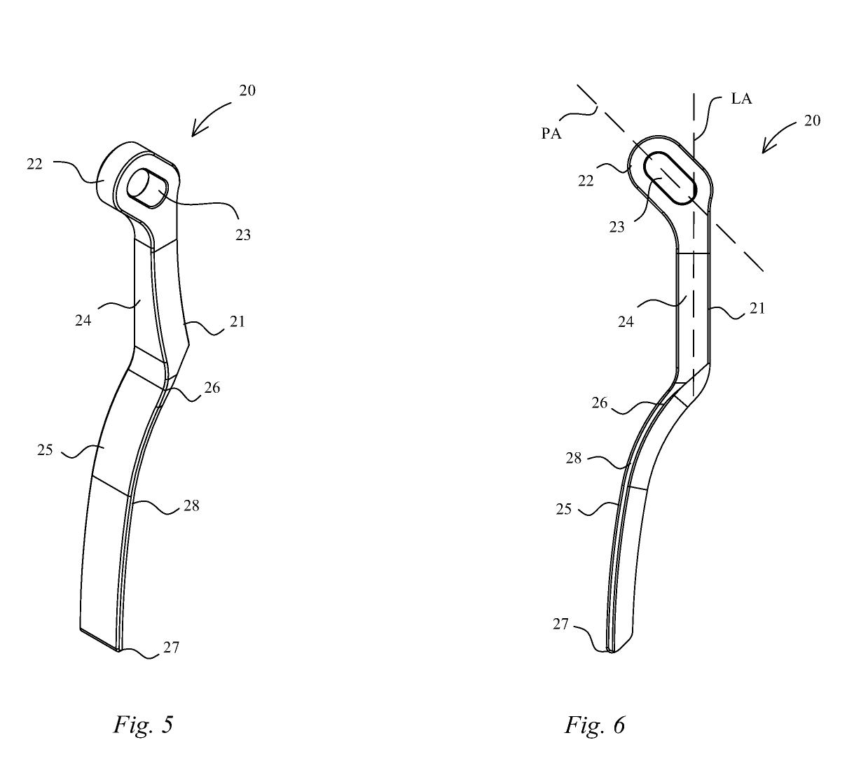

Referring to FIGS. 5 and 6, lateral chain travel limiter 20 is shown including body 21 having head 22 through which elongated mounting aperture 23 is formed. As shown, elongated mounting aperture 23 includes primary axis PA that lies oblique to axis A of body 24. As shown neck 24 is interposed between and connected at either end to head 22 and chain return finger 25. In a preferred embodiment chain return finger 25 of lateral chain travel limiter 20 has arcuate face 25 that curves continuously from and tapered leading edge 28. In a preferred embodiment chain return finger 25 of lateral chain travel limiter 20 has a gently curved arcuate face 25 extending from neck/return transition 26 to tip 27 and a tapered leading edge 28.

FIG. 6 also shows that according to the preferred embodiment, mounting aperture 23 is formed having an elongated slot having a primary axis PA that is set oblique to a longitudinal axis LA of body 21 of lateral chain travel limiter 20. A distance of gap G between face of chain return finger 25 and chain 15 when properly engaged with by inner chain ring 16 may be adjusted by sliding head 22 of lateral chain travel limiter 20 with screw 29 loosened and retightening when a desired gap G is observed.

The foregoing description of the illustrated embodiments has been presented for purposes of illustration and description. It is not intended to be exhaustive or to limit the invention to the precise form or to exemplary embodiment(s) and implementation(s) disclosed. Numerous modifications and variations will be apparent to practitioners skilled in this art. Process steps described might be interchangeable with other steps in order to achieve the same result. At least one preferred embodiment was chosen and described in order to best explain the principles of the invention and a best mode of practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, or method step in the present disclosure is intended to be dedicated to the public regardless of whether the element, component, or method step is explicitly recited in the following claims. No claim element herein is to be construed under the provisions of 35 U.S.C. Sec. 112, sixth paragraph unless the element is expressly recited using the phrase “means for . . . ”

We claim:

1. A chain lateral travel limiter for a bicycle having a frame and a chain drive assembly connected to the frame, the chain lateral travel limiter comprising a body including a head, the head adapted for attachment to the frame, the body including a chain return finger attached to and extending from the head, the chain return finger including an arcuate face.

2. The chain lateral travel limiter of claim 1 further comprising a neck connected at first end to the head and at a second end to the chain return finger.

3. The chain lateral travel limiter of claim 1 wherein the arcuate face further comprises a continuously curving face.

4. The chain lateral travel limiter of claim 1 wherein the chain return finger further comprises a tapered leading edge.

5. The chain lateral travel limiter of claim 1 wherein the head further comprises a mounting aperture adapted for receiving a mounting screw for attachment to the frame.

6. The chain lateral travel limiter of claim 1 wherein the head further comprises an elongated mounting aperture, the elongated mounting aperture having a primary axis lying oblique to an axis of the body, the elongated mounting aperture adapted for receiving a mounting screw for attachment to the frame.

7. The chain lateral travel limiter of claim 1 further comprising a tube clamp connected to the head, the tube clamp adapted for attachment to the frame.

8. A chain lateral travel limiter for a bicycle having a frame and a chain drive assembly connected to the frame, the chain lateral travel limiter comprising:
a body including a head, the head adapted for attachment to the frame;
a neck connected at a first end to the head;
a chain return finger the body attached to and depending from the neck, the chain return finger including an arcuate face.

9. The chain lateral travel limiter of claim 8 wherein the arcuate face further comprises a continuously curving face.

10. The chain lateral travel limiter of claim 8 wherein the chain return finger further comprises a tapered leading edge.

11. The chain lateral travel limiter of claim 8 wherein the head further comprises a mounting aperture adapted for receiving a mounting screw for attachment to the frame.

12. The chain lateral travel limiter of claim 8 wherein the head further comprises an elongated mounting aperture, the elongated mounting aperture having a primary axis lying oblique to an axis of the body, the elongated mounting aperture adapted for receiving a mounting screw for attachment to the frame.

13. The chain lateral travel limiter of claim 8 further comprising a tube clamp connected to the head, the tube clamp adapted for attachment to the frame.

14. A chain drive assembly for a bicycle for a bicycle having a frame, the chain drive assembly comprising:
a rear sprocket mounted to the frame;
at least two front chain rings mounted to the frame;
a chain mounted for rotational movement with the rear sprocket and at least one of the at least two front chain rings;
a front dérailleur assembly mounted to the frame the front dérailleur adapted to selectively shift the chain laterally from an outer chain ring of the at least two front chain rings to an inner chain ring of the at least two front chain rings;
a chain lateral travel limiter including a body having a head, the head adapted for attachment to the frame, the body including a chain return finger attached to and extending from the head, the chain return finger including an arcuate face, the chain lateral travel limiter positioned proximate to the inner chain ring of the at least two front chain rings, so that during a shifting event wherein the front derailleur assembly operates to shift the chain laterally from the outer of the at least two front chain rings to the inner of the at least two front chain rings, and in the event that the front derailleur shifts the chain laterally from a first plane defined by the outer chain ring to second plane defined by the inner chain ring and the chain travels laterally beyond the second plane defined by the inner chain ring, the chain is caught against the chain lateral travel limiter and guided in a manner that redirects the chain to the second plane defined by the inner chain ring to engage the inner chain ring.

15. The chain lateral travel limiter of claim 14 further comprising a neck connected at first end to the head and at a second end to the chain return finger.

16. The chain lateral travel limiter of claim 14 wherein an outer chain ring of the at least two front chain rings includes a diameter and an inner chain ring of the at least two front chain rings includes a diameter smaller than the diameter of the outer chain ring.

17. The chain lateral travel limiter of claim 14 wherein the chain return finger further comprises a tapered leading edge.

18. The chain lateral travel limiter of claim 14 wherein the head further comprises a mounting aperture adapted for receiving a mounting screw for attachment to the frame.

19. The chain lateral travel limiter of claim 14 wherein the head further comprises a elongated mounting aperture, the elongated mounting aperture having a primary axis lying oblique to an axis of the body, the elongated mounting aperture adapted for receiving a mounting screw for attachment to the frame.

20. The chain lateral travel limiter of claim 14 further comprising a tube clamp connected to the head, the tube clamp adapted for attachment to the frame.
